(19) United States
(12) Patent Application Publication
(10) Pub. No.: US 2006/0013329 A1
(43) Pub. Date: Jan. 19, 2006

(54) Signal transmitting device and method of multiple-antenna system

(75) Inventors: Kwang-Hee Han, Yongin-si (KR); Chung-Gu Kang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/179,488

(22) Filed: Jul. 13, 2005

(30) Foreign Application Priority Data
Jul. 14, 2004 (KR) 2004-54950

(51) Int. Cl. H04B 7/02

(52) U.S. Cl. 375/267

(57) ABSTRACT

A signal transmitting device and method are provided which separate signals simultaneously transmitted through a multiple-antenna system into respective sub-channel signals. The method includes separating a transmission channel into spatial sub-channels in a time division duplex (TDD) system using a multiple-antenna system. The factors for channel separation of a current time slot are calculated using one of the factors calculated during a previous time slot, thereby reducing computational complexity.

### CROSS-REFERENCE TO RELATED APPLICATIONS

This application claims the benefit under 35 U.S.C. §119(a) of Korean Patent Application No. 10-2004-0054950 entitled “SIGNAL TRANSMITTING DEVICE AND METHOD OF MULTIPLE-ANTENNA SYSTEM”, filed in the Korean Intellectual Property Office on Jul. 14, 2004, the entire disclosure of which is incorporated herein by reference.

### BACKGROUND OF THE INVENTION

1. Field of the Invention

The present invention relates to a signal transmitting device and method of a mobile communication system. More particularly, the present invention relates to a signal transmitting device and method for separating a multiple signal received through a multiple-antenna into respective signals.

2. Description of the Related Art

As the mobile communication system is developed and the number of users is increased, the quantity of data to be transmitted is also increased. Thus, the current mobile communication system requires a method for efficiently transmitting a large quantity of data. As one such method of efficient data transmission, multiple-input multiple-output (MIMO) has been suggested. The MIMO method is one of the next-generation radio access technologies and is also a core element of radio link technology. The MIMO method can be used to simultaneously transmit different data through a multiple-antenna at transmitting and receiving ends of the mobile communication system. When the multiple-antenna is used, signals respectively transmitted through the transmitting antennas get jumbled, and the jumbled signals are then received by the receiving antennas. Accordingly, there is a need for a means for separating the received signals into individual signals.

In the mobile communication system which employs the multiple-antenna system, a singular value decomposition (SVD) algorithm is used as a method for separating the respective channels. The SVD algorithm is an algorithm for estimating a singular value and right and left singular vector values, which are factors for separating the respective signals corresponding to the respective spatial sub-channels from a MIMO channel. A procedure for separating the MIMO channel into the respective spatial sub-channels using the factors estimated by the SVD algorithm is described in greater detail below.

A MIMO system which has n antennas at a transmitting end and a receiving end, respectively, forms an N×N radio channel matrix H between the transmitting end and the receiving end. If the SVD result of the radio channel H is,
H=USV*,
the transmitting end filters a transmission signal using a right singular vector V and then transmits it, and the receiving end filters a received signal using a left singular vector U*. As a result, the MIMO channel can be separated into a plurality of spatial sub-channels as noted below in Equations (1)-(3),
t=Vx (1)
r=Ht+n=HVx+n=USV*Vx+n (2)
\hat{x}=U*r=U*(USV*Vx+n)=Sx+ñ (3)
wherein t is a filtered transmitting signal vector, x is a transmitting symbol vector, r is a received signal vector which has passed through the radio channel H, n is an additive white Gaussian noise (AWGN) vector, and \hat{x} is an estimated transmitting symbol vector obtained by filtering the received signal. Equation (4) below is an equation in which Equation (3) is expressed in a unit of elements.
\hat{x}_{A}=\sqrt{λ_{A}}x_{A}+ñ_{A}(n=1,2, . . . , N) (4)

As can be seen in Equation (4), the respective transmitting symbols xₐ pass through only certain spatial sub-channels having a gain \sqrt{λₙ}.

Conventional methods for separating the MIMO channel into the spatial sub-channels using the SVD algorithm can generally be classified into one of two methods.

The first method utilizes a channel estimation algorithm and an SVD algorithm. At the receiving end, MIMO channel information is obtained through the channel estimation algorithm, and the SVD algorithm is performed using the obtained MIMO channel information as an input signal, thereby calculating a singular value and right and left singular vectors of the respective spatial sub-channels which are needed for separating the MIMO channel into a plurality of spatial sub-channels. However, the first method has a disadvantage in that the SVD algorithm can only be applied after the MIMO channel information is obtained, and further, it is also very complicated since a time-varying channel which varies according to time is applied. For example, the R-SVD algorithm has computational complexity of about 26N³, where N is the number of receiving antennas.

The second method estimates the singular value and the singular vector using a feature of a time division duplex (TDD) system without using the channel estimation procedure. The TDD system has a feature wherein a forward channel and a reverse channel have a reciprocal relation. The receiving end performs the SVD algorithm which finds a correlation matrix of a channel from a correlation matrix of a received signal, and finds the singular value and the singular vector from the correlation matrix. This method is a type of blind algorithm which does not use a training sequence, and which does not require the channel estimation procedure. Thus, the second method has an advantaging of reducing the computational complexity as compared to the first method described above. However, the second method cannot be used when different powers are allocated to the respective transmitting symbols to transmit the signal, since it is performed under the assumption that the transmitting powers of all transmitting symbols are equal. One of the main reasons why the SVD algorithm is performed to estimate the singular value or the singular vector is power control, and thus the second method, which cannot perform the power control, has a severe problem therein.

Accordingly, a need exists for a system and method for separating received signals into individual signals with minimal complexity.

### SUMMARY OF THE INVENTION

It is, therefore, an objective of the present invention to substantially solve the above and other problems, and provide a signal transmission device and method of a multiple-antenna system which can reduce computational complexity when estimating factors for separating a received signal into the respective spatial sub-channels.

It is another objective of the present invention to provide a signal transmission device and method of a multiple-antenna system which estimate factors for separating a signal received through the multiple-antenna into the respective spatial sub-channels, while reducing computational complexity and controlling power of the respective transmitting symbols.

According to an aspect of the present invention, a signal transmitting device is provided for a time division duplex (TDD) multiple-antenna system which performs signal transmissions with another party's system using a multiple receiving antenna and a multiple transmitting antenna, which are respectively comprised of at least two antennas, the device comprising a receiving operation part for estimating a first factor for separating a multiple-input multiple-output (MIMO) channel signal received through the multiple receiving antenna into the respective spatial sub-channel signals, separating the received signal into the respective spatial sub-channel signals using the estimated first factor and outputting the respective spatial sub-channel signals, and a transmitting operation part for receiving a second factor which is a value contained in the first factor from the receiving operation part and converting a transmitting signal using the second factor and then transmitting the converted second factor to the other party's system through the multiple transmitting antenna.

According to another aspect of the present invention, a signal transmitting method is provided for a multiple-antenna system which performs signal transmission with another party's system using at least two receiving and transmitting antennas respectively, the method comprising a first step of receiving a signal from the other party's system through the receiving antennas, and a second step of calculating a first factor for separating the received signal into the respective spatial sub-channel signals.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram of a multiple-antenna system having a transmitting end which includes N antennas and a transmitting filter, and a multiple-antenna system having a receiving end which includes N antennas and a receiving filter;

FIG. 2 is a schematic diagram illustrating signal transmission of a multiple-antenna system which has a transmitting end having N antennas and a transmitting filter, and a receiving end having N antennas and a receiving filter;

FIG. 3 is a diagram illustrating signal transmission according to time between two TDD systems having a multiple-antenna system according to an embodiment of the present invention;

FIG. 4 is a diagram illustrating information exchanged between two TDD systems for the signal transmission of FIG. 3;

FIG. 5 is a diagram illustrating a method which estimates factors for channel separation performed in the two multiple-antenna systems according to an embodiment of the present invention; and

FIGS. 6 to 8 are simulation graphs illustrating effects of embodiments of the present invention.

Throughout the drawings, like reference numerals will be understood to refer to like parts, components and structures.

### DETAILED DESCRIPTION OF THE EXEMPLARY EMBODIMENTS

The present invention will now be described in greater detail with reference to the accompanying drawings, in which, exemplary embodiments of the present invention are shown. The present invention may, however, be embodied in different forms and should not be construed as limited to the embodiments set forth herein.

The present invention is comprised of a system and method for converting a multiple-input multiple-output (MIMO) channel formed by the use of a multiple-antenna, into a plurality of independent spatial sub-channels using a channel feature of a time division duplex (TDD) system.

The multiple-antenna system is comprised of two or more transmitting antennas and two or more receiving antennas, and transmits a signal through the antennas. Signal transmission between the multiple-antenna systems is described in greater detail below.

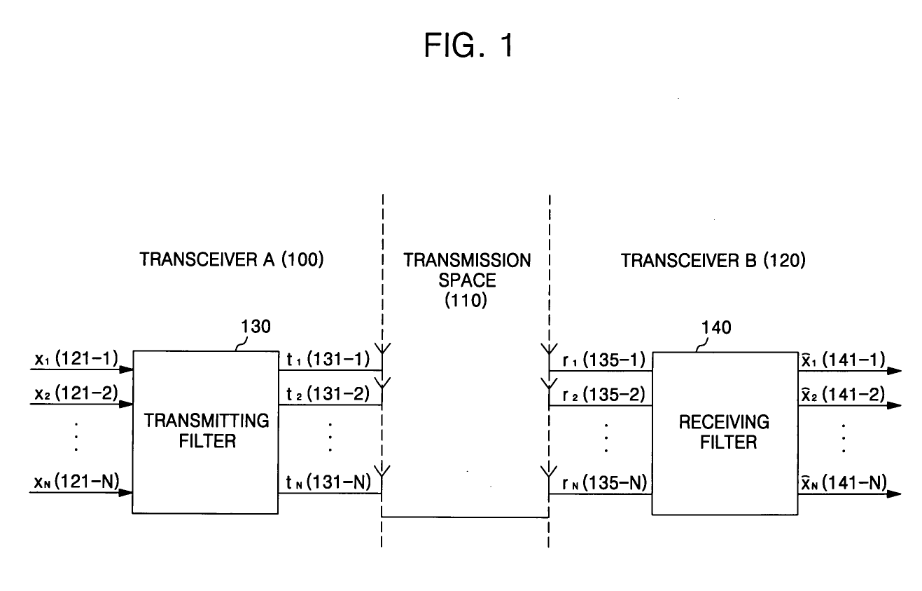

FIG. 1 is a schematic diagram of a multiple-antenna system having a transmitting end which includes N antennas and a transmitting filter, and a multiple-antenna system having a receiving end which includes N antennas and a receiving filter.

In particular, the transmitting end of a transceiver A 100 of the multiple-antenna system A, and the receiving end of a transceiver B 120 of the multiple-antenna system B, are both shown in FIG. 1. The transceiver A 100 converts signals to be transmitted, x₁ 121-1 to x_{N} 121-N, into transmitting signals, t₁ 131-1 to t_{N} 131-N, using the transmitting filter 130, and transmits the signals through transmitting antennas. The signals transmitted from the transceiver A 100 are received by receiving antennas of the transceiver B 120 through a transmission space 110 having a transfer function H. The transceiver B 120 converts the received signals, r₁ 135-1 to r_{N} 135-N, into signals, \hat{x}₁ 141-1 to \hat{x}_{N} 141-N, that are separated according to the spatial sub-channels through the receiving filter 140.

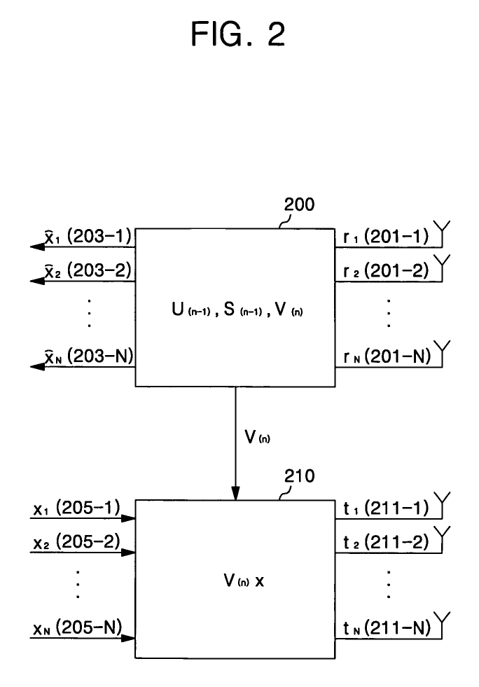

A device and method for estimating factors which are used for the receiving filter 140 of the transceiver B 120 to convert the received signals, r₁ 135-1 to r_{N} 135-N, into signals, \hat{x}₁ 141-1 to \hat{x}_{N} 141-N, that are separated according to the spatial sub-channels, are described in greater detail below. Embodiments of the present invention use factors received from the transceiver A 100 to estimate factor values of the receiving filter 140. Thus, a signal transmission device of the multiple-antenna system according to an embodiment of the present invention can have the configuration of FIG. 2.

FIG. 2 is a schematic diagram illustrating signal transmission of a multiple-antenna system which has a transmitting end having N antennas and a transmitting filter, and a receiving end having N antennas and a receiving filter.

The transmitting end of the transceiver A 100 and the receiving end of the transceiver B 120 are shown separately in FIG. 1, whereas transceivers having both the transmitting and receiving ends are shown in FIG. 2. That is, the transmitting and receiving ends of each transceiver A 100 or B 120 can contain both the receiving filter 200 and the transmitting filter 210, respectively.

The receiving filter 200 at the receiving end estimates factors for converting signals, r₁ 201-1 to r_{N} 201-N, received from a receiving antenna into signals, \hat{x}₁ 203-1 to \hat{x}_{N} 203-N, that are separated according to the spatial sub-channels, and performs signal conversion using the estimated factors. The values U(n−1), S(n−1), and V(n), of FIG. 2 denote factors used in an embodiment of the present invention. One receiving filter 200 is shown in FIG. 2, but the receiving filter 200 can be divided into an operation part for estimating channel separating factors, and an operation part for performing channel separation using the estimated factors.

The V(n) value, which is one of the factors used for converting the received signal, is used for converting the transmitting signal at the transmitting filter 210. The transmitting signal is converted such that the channel separation can be performed in the other party's system which has received the corresponding signal.

The transmitting filter 210, which has received the factor V(n) from the receiving filter 200, converts signals to be transmitted, x₁ 205-1 to x_{N} 205-N, into transmitting signals, t₁ 211-1 to t_{N} 211-N, using the factor V(n), and transmits the signals through a transmission space 110 which is expressed as a transfer function H.

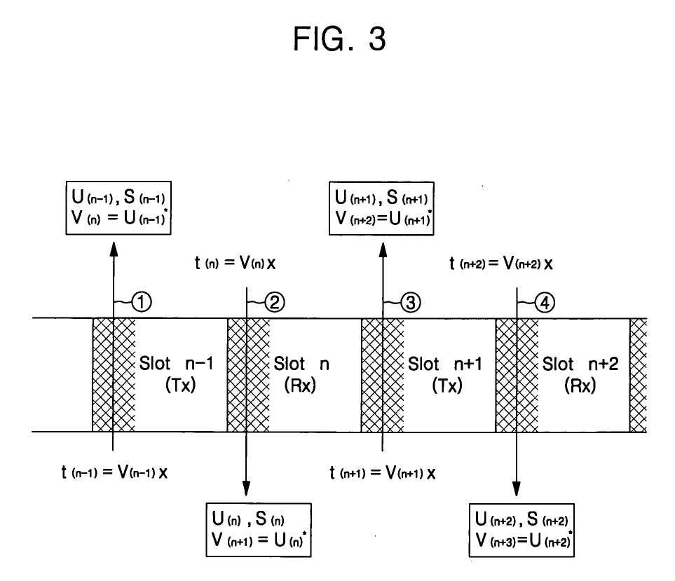

FIG. 3 is a diagram illustrating signal transmission according to time between two TDD systems having a multiple-antenna system according to an embodiment of the present invention. In particular, FIG. 3 shows a time slot structure and signal transmission for estimating a singular value and a singular vector of a time-varying channel in a TDD point-to-point communication environment. In the case of TDD point-to-point communication, two transceivers which communicate with each other occupy a time slot in turn, and transmit data only through the time slot occupied by itself. In the embodiments of the present invention, each time slot is divided into a training symbol period and a data period. A training symbol, filtered at the receiving end, is transmitted from the transmitting end during the training symbol period. The training symbol is used to estimate a factor for the channel separation.

At a time point 1 in FIG. 3, the transceiver A 100 transmits the training symbol to the transceiver B 120. The receiving filter 200 of the transceiver B 120, which has received the training symbol from the transceiver A 100 during the training symbol period of a (n−1)ₜₕ time slot, applies a minimum mean square error (MMSE) algorithm and a QR decomposition algorithm to a signal received during the data period of the corresponding time slot to estimate factors for a singular value and a left singular vector, and performs the channel separation using the estimated factors. The receiving filter 200 uses a U* value, which is a complex conjugate of a U value which is the left singular vector factor among the estimated factors, as a right singular vector factor (i.e., a V value) of the next time slot. This is possible because the receiving and transmitting channels of the TDD system have a reciprocal relation to each other.

At a time point 2 in FIG. 3, the transmitting filter 210 of the transceiver B 120 transmits a training symbol, which is filtered as a V value, during the training period of the nth time slot to the transceiver A 100. The MMSE algorithm and the QR decomposition algorithm will be described in greater detail below with reference to the following Equations.

At time points 3 and 4 in FIG. 3, the same procedure as at the time points 1 and 2 is repeated, and the procedure is repetitively performed for all time slots, thereby estimating the factors for the singular value and the singular vector of the time-varying channel.

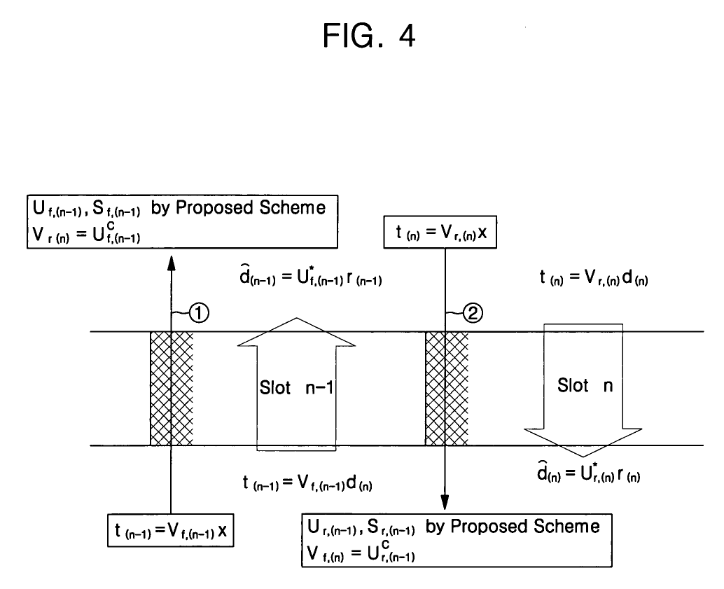

The procedure at the time points 1 and 2 will now be described in greater detail with reference to FIG. 4.

FIG. 4 is a diagram illustrating signal transmission through the (n−1)ₜₕ time slot and the nₜₕ time slot, i.e., time points 1 and 2 of FIG. 3.

Referring to FIG. 4, the transmitting end transmission-filters a predetermined training symbol x using a conjugate matrix of a matrix U₍ₙ₋₂₎ obtained at an immediately previous time slot during the training symbol period of a (n−1)ₜₕ time slot, and transmits it to the receiving end. That is,
V₍ₙ₋₁₎=U^{C}₍ₙ₋₂₎
It is received in the form of,
“r₍ₙ₋₁₎=H₍ₙ₋₁₎V₍ₙ₋₁₎x+n₍ₙ₋₁₎
and the receiving end obtains an optimum receiving filter M of the training symbol period based on the MMSE criteria using the received singular vector and the training symbol x. When the optimum receiving filter M is obtained, the receiving end obtains a matrix, U₍ₙ₋₁₎, S₍ₙ₋₁₎ of H₍ₙ₋₁₎, through the QR decomposition algorithm, such as a modified Gram-Schmidt algorithm.

During the data period of the (n−1)ₜₕ time slot, the transmitting end filters the transmitting data vector using,
V₍ₙ₋₁₎=U^{C}₍ₙ₋₂₎
which is the same as that used during the training symbol period, and transmits it to the receiving end. The receiving end filters the received signal using a conjugate transpose matrix of the matrix U₍ₙ₋₁₎, which is obtained during the training symbol period, to estimate the transmitted data vector. The conjugate matrix of the matrix U₍ₙ₋₁₎ is used as the transmitting filter value for the nth time slot. That is,
V₍ₙ₎=U^{C}₍ₙ₋₁₎

Operations of the embodiments of the present invention described above are described in greater detail below using the following Equations.

In the TDD multiple-antenna system, if it is assumed that the same channel is used for both forward and reverse directions, that is, if it is a reciprocal channel, a relation,
Hᵣ=H^{T}_{ƒ}
is formed between a forward channel matrix H_{ƒ} and a reverse channel matrix Hᵣ. That is, the reverse channel matrix becomes a transposed matrix of the forward channel matrix.

If the SVD result of H_{ƒ} is,
H_{ƒ}=U_{ƒ}S_{ƒ}V_{ƒ}*
and the SVD result of Hᵣ is,
Hᵣ=UᵣSᵣVᵣ*
the TDD multiple-antenna channels have a relation therebetween as described by Equation (5) below.
UᵣSᵣVᵣ*=(U_{ƒ}S_{ƒ}V_{ƒ}*)^{T} (5)
Here, A* is a conjugate transpose matrix of A. Since,
Sᵣ=S_{ƒ}^{T}
the singular vector matrixes of both direction channels, i.e., unit orthogonal matrixes, have a relation therebetween as described below by Equation (6).
Vᵣ=U_{ƒ}^{C}, V_{ƒ}=Uᵣ^{C} (6)
Here, A^{C} is a conjugate matrix of A.

Equation (5) shows that a complex conjugate value of the left singular vector value is used as a right singular vector of the next time slot.

The singular value and the singular vector values, which are factors for separating the corresponding channel, can be estimated by the following procedure using a correlation of the channels shown in Equation (6).

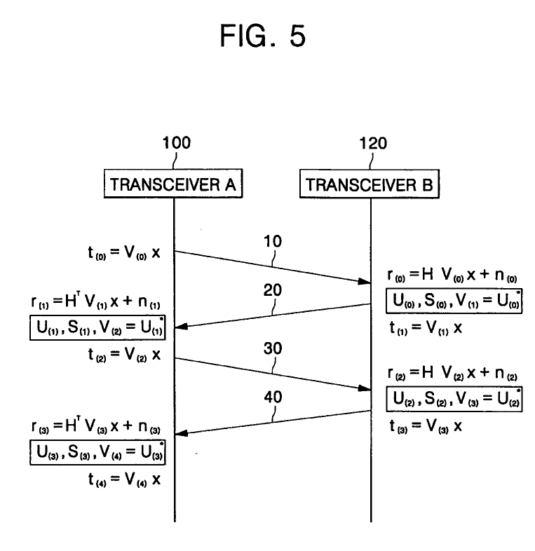

FIG. 5 is a diagram illustrating a method for estimating factors for channel separation performed in two multiple-antenna systems according to an embodiment of the present invention.

The factor estimating method is described in greater detail below in the order described in FIG. 1.

First, the transceiver A 100 filters the training symbol x using a predetermined right unit orthogonal matrix V₍₀₎. The transceiver A 100 then transmits the filtered training symbol V₍₀₎x to the transceiver B 120 at step 10.

The transceiver B 120 then estimates a left unit orthogonal matrix U₍₀₎ and a singular value matrix S₍₀₎ using the filtered training symbol received from the transceiver A 100, and filters the training symbol x using U₍₀₎*, i.e., V₍₁₎. The transceiver B 120 then transmits the filtered training symbol to the transceiver A 100 at step 20.

The transceiver A 100 then estimates a left unit orthogonal matrix U₍₁₎ and a singular value matrix S₍₁₎ using the filtered training symbol which is received, and filters the training symbol x using U₍₁₎*, i.e., V₍₂₎. The transceiver A 100 then transmits the filtered training symbol to the transceiver B 120 at step 30.

The transceiver B 120 then estimates a left unit orthogonal matrix U₍₂₎ and a singular value matrix S₍₂₎ using the filtered training symbol received from the transceiver A 100, and filters the training symbol x using U₍₂₎*, i.e., V₍₃₎. The transceiver B 120 then transmits the filtered training symbol to the transceiver A 100 at step 40.

The procedure of steps 20 to 40 is repeated until the left unit orthogonal matrix and the singular value matrix are converged. Here, if it is assumed that a channel is constant during the respective time slots, it can be imagined that a plurality of training symbols are exchanged between a transmitting end and a receiving end during the respective time slots for the sake of perfect convergence of the singular value. However, the actual time-varying channel has a small degree of correlation between sequential time slots due to channel variation, and so even though one training symbol is used per each time slot, it can show the characteristics which follow the singular value.

A procedure of FIG. 5 can be more clearly understood with reference to FIG. 3 described above.

A method of performing the present invention using the MMSE algorithm and the QR decomposition algorithm is described in greater detail below with reference to the following Equations.

Temporal singular value and singular vectors of all spatial sub-channels can be obtained by applying the MMSE criterion to obtain the optimum receiving filter value of the training symbol period, and then applying the Gram-Schmidt procedure to the obtained receiving filter value. First, the optimum receiving filter value M is determined using the MMSE criterion such as Equation (7), as a value which minimizes the square of a difference between the training symbol x and the estimation transiting symbol \hat{x}.
Mn_{M}E∥x−(MHVx+Mn)∥² (7)

In Equation (7), M is calculated as in Equation (8) below,
mₙ=R⁻¹pₙ(n=1,2, . . . , N) (8)
wherein Mₙ denotes an nₜₕ row vector of M, R denotes a correlation matrix of the receiving signal vector r, and pₙ denotes a correlation vector between xₙ and r. A relation of Equation (9) below, can then be understood from Equation (7).
x≈MHVx=M(USV*)Vx (9)
Thus, M can be expressed as in Equation (10) below,
M≈(US)⁻¹=S⁻¹U⁻¹ (10)
wherein U is a unit orthogonal matrix, and thus, M* can be expressed as,
M*=US⁻¹
Further, S⁻¹ is also a diagonal matrix, and thus, has a relation of Equation (11) as described below, wherein if,
M*=QT
then,
U≈Q, S≈T⁻¹(\sqrt{λₙ}≈γₙ, n=1,2, . . . , N) (11)
wherein Q and T can be obtained by the QR decomposition, Q denotes a unit orthogonal matrix, T denotes an upper triangular matrix, and γₙ denotes an nth diagonal factor of T−1. The QR decomposition can be implemented by various algorithms, such as a modified Gram-Schmidt algorithm, Householder Reflections, Given Rotations, and so forth.

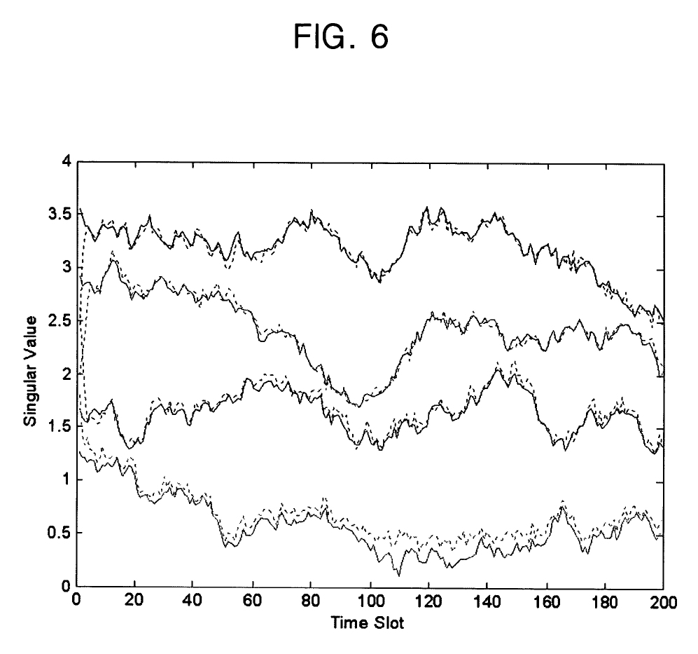

A simulation result of an embodiment of the present invention is described in greater detail below and illustrated in FIGS. 6 to 8.

As described above, the present invention includes an assumption that there is little channel information. Thus, if it is further assumed that computational complexity required for calculating the optimum receiving filter value of the training symbol period which is shown in Equation 8, is almost equal to the computational complexity required for estimation of the transfer function H, i.e., channel estimation by the existing SVD algorithm, almost all of the computational complexity of embodiments of the present invention results from the modified Gram-Schmidt algorithm, and computational complexity of about 2N³ are spent for it. Thus, it can be understood that the computational complexity of the present invention is reduced to one thirteenth ( 1/13) as compared to the conventional art, which requires the computational complexity of about 26N³ in the state where H is given.

FIGS. 6 to 8 are simulation graphs illustrating effects of embodiments of the present invention.

FIG. 6 is a simulation graph illustrating a singular value estimation result of the TDD multiple-antenna system where N is 4, according to an embodiment of the present invention.

In the simulation example of FIG. 6, f_{d} is set to 40 Hz, and a transmission rate per spatial sub-channel is 200K symbols/sec. A length of the time slot and a length of the training symbol used are set to 100 symbols and 20 symbols, respectively.

A channel for individual antennas used a first-order AR model and was modeled as a Rayleigh fading channel, and variation of channel size according to it can be defined by the following Equation (12) below,
hₜαhₜ₋₁νₜ (12)
wherein,
α=E[hₜhₜ₋₁^{C}]=J₀(2πƒ_{d}T_{S})exp{j2πƒ₀T_{S}}
and wherein νₜ is a complex Gaussian variable whose variance is (1−|α|²) and average is 0, and it is independent from hₜ₋₁. Also, ƒ₀ denotes a carrier frequency offset, T_{S} denotes a transmission symbol cycle, J₀(·) denotes a 0th-order Bessel function, and ƒ_{d} denotes a maximum Doppler shift. In this simulation, ƒ₀=0 was assumed.

Referring to FIG. 6, it can be understood that when a signal to noise ratio (SNR) is 20 dB, all of the four (4) singular values estimated by the embodiment of the present invention are similar to the singular value estimated by the conventional art, which employs the SVD algorithm in the state where H is given.

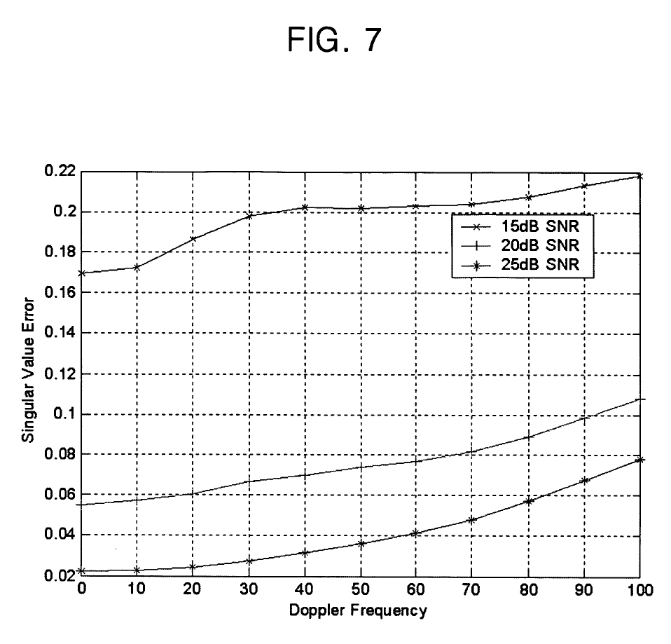

FIG. 7 is a simulation graph illustrating an average difference between the four singular values estimated by the method in accordance with an embodiment of the present invention, and the singular value obtained through the SVD algorithm in the state where H is given as the Doppler frequency shift is increased at the SNR of 15 dB, 20 dB, and 25 dB. It can be understood that an error resulting from an increment of the Doppler frequency is relatively low if the SNR is sufficiently high. In this simulation, the SNR is regarded as sufficiently high when the SNR is greater than 20 dB.

A method of power control in accordance with an embodiment of the present invention is described in greater detail below.

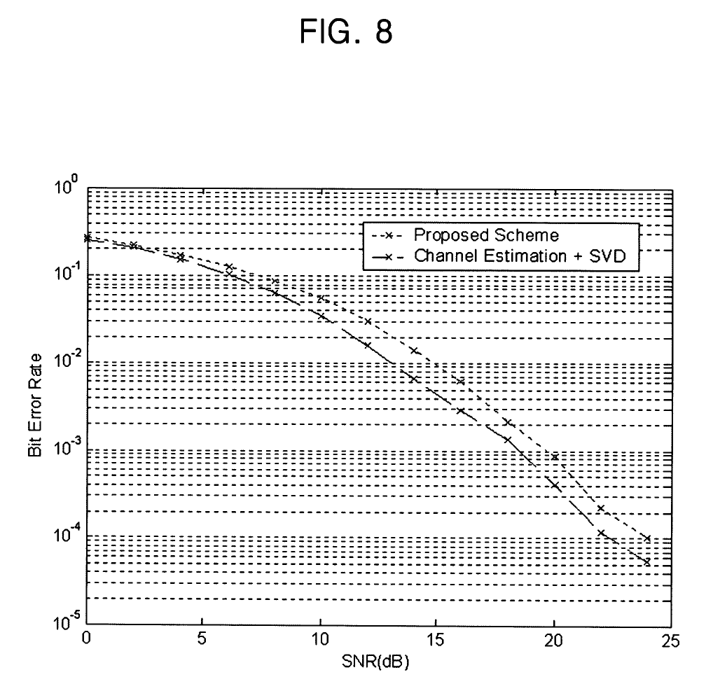

FIG. 8 is a simulation graph illustrating the bit error rate (BER) performance of an embodiment of the present invention and the conventional art with respect to the QPSK modulation. Here, the singular value estimated by the embodiment of the present invention and the singular value estimated by the conventional art, are respectively used to control the powers allocated to the respective transmission symbols. The sub-channel having the worst channel gain among the spatial sub-channels is not used for signal transmission. The power values applied to the respective transmitting symbols are defined by Equation (13) below, and is used to implement the power control method for improving the BER performance by making the SNRs of all used sub-channels equal at the receiving end.

$$\begin{matrix}{α}_{n} = \frac{{λ}_{N - n}}{{λ}_{1} + {λ}_{2} + {λ}_{3}} ( n = 1 , 2 , 3 ) \\ {α}_{4} = 0\end{matrix} \qquad ( 13 )$$

That is, according to embodiments of the present invention, it is possible to estimate the factors for separating the signal in which several channels are mixed into signals corresponding to the respective channels, while performing transmission power control through low computational complexity.

As described above, according to embodiments of the present invention, it is possible to precisely determine the channel separation factors using low computational complexity, such that precise channel separation can be performed. Also, it is possible to freely control the power of the respective transmission symbols.

While the present invention has been described with reference to exemplary embodiments thereof, it will be understood by those skilled in the art that various changes in form and detail may be made therein without departing from the scope of the present invention as defined by the following claims

What is claimed is:

1. A signal transmitting device of a time division duplex (TDD) multiple-antenna system which performs signal transmission with another party's system using a multiple receiving antenna and a multiple transmitting antenna which are respectively comprised of at least two antennas, the device comprising:
a receiving operation part for estimating a first factor for separating a multiple-input multiple-output (MIMO) channel signal received through the multiple receiving antenna into respective spatial sub-channel signals, separating the received signal into the respective spatial sub-channel signals using the estimated first factor, and outputting the respective spatial sub-channel signals; and
a transmitting operation part for receiving a second factor which is a value in the first factor from the receiving operation part, and converting a transmitting signal using the second factor and transmitting the converted second factor to the other party's system through the multiple transmitting antenna.

2. The device of claim 1, wherein the first factor is comprised of:
at least one of a left singular vector value U, a singular value S, and a right singular vector value V, such that a transfer function H of a transmission space is expressed by H=USV*.

3. The device of claim 2, wherein the receiving operation part is configured to receive a right singular vector value of a previous time slot from the other party's system and calculate a singular value and a left singular vector value of a current time slot using the received right singular vector value.

4. The device of claim 3, wherein the left singular vector value of the current time slot is comprised of a conjugate transposed operation value of the right singular vector value of the previous time slot received from the other party's system.

5. The device of claim 3, wherein the receiving operation part is configured to calculate the singular value and the singular vector value using a minimum mean square error (MMSE) algorithm and a QR decomposition algorithm.

6. The device of claim 1, wherein the receiving operation part is comprised of:
a first operation part for calculating the first factor for separating the received signal into the respective spatial sub-channel signals; and
a second operation part for separating the received signal into the respective spatial sub-channel signals using the calculated first factor and outputting the respective spatial sub-channel signals.

7. A signal transmitting method of a multiple-antenna system which performs signal transmission with another party's system using at least two receiving and transmitting antennas, respectively, the method comprising the steps of:
receiving a signal from the other party's system through the receiving antennas; and
calculating a first factor for separating the received signal into respective spatial sub-channel signals.

8. The method of claim 7, wherein the first factor is comprised of:
at least one of a left singular vector value U, a singular value S, and a right singular vector value V, such that a transfer function H of a transmission space is expressed by H=USV*.

9. The method of claim 7, wherein the step of calculating a first factor comprises the steps of:
receiving a right singular vector value of a previous time slot from the other party's system; and
calculating a singular value and a left singular vector value of a current time slot using the received right singular vector value.

10. The method of claim 9, wherein the left singular vector value of the current time slot is comprised of a conjugate transposed operation value of the right singular vector value of the previous time slot received from the other party's system.

11. The method of claim 9, further comprising the step of:
calculating the singular value and the singular vector value using a minimum mean square error (MMSE) algorithm and a QR decomposition algorithm.
